(19) United States
(12) Patent Application Publication
(10) Pub. No.: US 2025/0216870 A1
(43) Pub. Date: Jul. 3, 2025

(54) REMOTE MONITORING APPARATUS

(71) Applicant: TOYOTA JIDOSHA KABUSHIKI KAISHA, Toyota-shi (JP)

(72) Inventor: Shinichi NIWA, Nagoya-shi (JP)

(73) Assignee: TOYOTA JIDOSHA KABUSHIKI KAISHA, Toyota-shi (JP)

(21) Appl. No.: 18/999,215

(22) Filed: Dec. 23, 2024

(30) Foreign Application Priority Data
Dec. 28, 2023 (JP) 2023-223218

(51) Int. Cl. G05D 1/86; G05D 1/224; G05D 109/10; G05D 111/30

(52) U.S. Cl. CPC G05D 1/86; G05D 1/2247; G05D 2109/10; G05D 2111/32

(57) ABSTRACT

A remote monitoring apparatus monitors an operation of a vehicle based on values set for one or more parameters related to automated driving of the vehicle. The remote monitoring apparatus includes a memory configured to store in advance first information indicating values of the one or more parameters transmitted from the vehicle at a first timing, and a controller configured to compare, upon acquiring second information indicating values of the one or more parameters transmitted from the vehicle at a second timing later than the first timing, the first information stored in the memory with the second information, and generate update information indicating that a value of a parameter has been updated according to a comparison result.

### CROSS-REFERENCE TO RELATED APPLICATION

This application claims priority to Japanese Patent Application No. 2023-223218 filed on Dec. 28, 2023, the entire contents of which are incorporated herein by reference.

### TECHNICAL FIELD

The present disclosure relates to a remote monitoring apparatus.

### BACKGROUND

Patent Literature (PTL) 1 describes an operation management system in which the operation status of a vehicle is managed by a remote observer.

### CITATION LIST

### Patent Literature

PTL 1: JP 2022-045502 A

### SUMMARY

When an engineer has changed the value of a parameter for controlling automated driving of a vehicle on site, if the changed value of the parameter is not reflected in a remote monitoring apparatus at the remote monitoring center that remotely monitors the operation, the remote operator who monitors the operation of the vehicle at the remote monitoring center may stop the operation of the vehicle for confirmation as the actual traveling condition of the vehicle is different from the expected traveling condition based on the value of the parameter. As a result, the operation efficiency of the vehicle is reduced.

It would be helpful to enable remote operators to properly know the values of parameters set for a vehicle and improve the operation efficiency of the vehicle.

A remote monitoring apparatus according to the present disclosure is a remote monitoring apparatus for monitoring an operation of a vehicle based on values set for one or more parameters related to automated driving of the vehicle, the remote monitoring apparatus including:
a memory configured to store in advance first information indicating values of the one or more parameters transmitted from the vehicle at a first timing; and
a controller configured to:
   compare, upon acquiring second information indicating values of the one or more parameters transmitted from the vehicle at a second timing later than the first timing, the first information stored in the memory with the second information; and
   generate update information indicating that a value of a parameter has been updated according to a comparison result.

According to the present disclosure, remote operators can properly know the values of parameters set for a vehicle and the operation efficiency of the vehicle is improved.

### BRIEF DESCRIPTION OF THE DRAWINGS

In the accompanying drawings:

FIG. 1 is a diagram illustrating a configuration of a system according to an embodiment of the present disclosure;

FIG. 2 is a block diagram illustrating a configuration of a remote monitoring apparatus according to the embodiment of the present disclosure;

FIG. 3 is a block diagram illustrating a configuration of a server apparatus according to the embodiment of the present disclosure; and

FIG. 4 is a flowchart illustrating operations of the system according to the embodiment of the present disclosure.

### DETAILED DESCRIPTION

Hereinafter, an embodiment of the present disclosure will be described with reference to the drawings.

In the drawings, the same or corresponding portions are denoted by the same reference numerals. In the descriptions of the present embodiment, detailed descriptions of the same or corresponding portions are omitted or simplified, as appropriate.

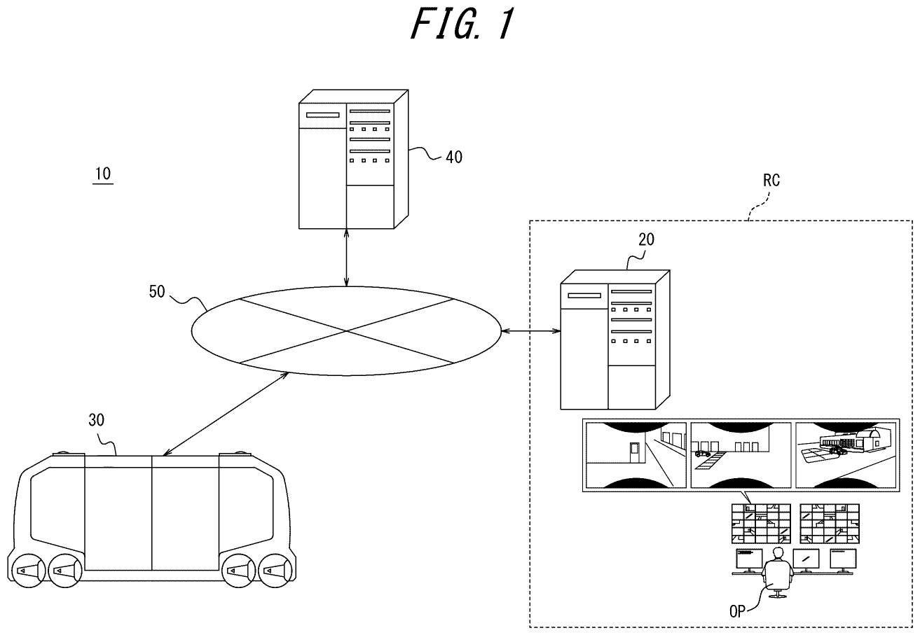

A configuration of a system 10 according to the present embodiment will be described with reference to FIG. 1.

The system 10 according to the present embodiment includes a remote monitoring apparatus 20, at least one vehicle 30, and a server apparatus 40.

The remote monitoring apparatus 20 can communicate with the server apparatus 40 via a network 50. The remote monitoring apparatus 20 may be able to communicate with the vehicle 30 via the network 50. The system 10 is used, for example, to provide a mobility service such as MaaS. The term “MaaS” is an abbreviation of Mobility as a Service. There may be multiple remote monitoring apparatuses 20, vehicles 30, and server apparatuses 40, respectively.

The server apparatus 40 can communicate with the vehicle 30, as well as the remote monitoring apparatus 20, via the network 50.

The remote monitoring apparatus 20 is installed in a facility such as a data center and operated by an operation manager managing the system 10. The remote monitoring apparatus 20 is a computer such as a server that belongs to a cloud computing system or other computing system. Alternatively, the remote monitoring apparatus 20 is installed in a control room of the system 10 and used by the operation manager. Alternatively, the remote monitoring apparatus installed in the control room may be shared by two or more operation managers. In the present embodiment, the remote monitoring apparatus 20 is installed in a remote monitoring center RC that remotely monitors the vehicle 30. At the remote monitoring center RC, the remote operator OP as the administrator of the system 10 monitors and remotely supports the operation of the vehicle 30.

The server apparatus 40 is installed in a facility such as a management center to acquire, store, and process data transmitted from the vehicle 30 and to manage the automated driving of the vehicle 30. The management center is, for example, an AD center. The term “AD” is an abbreviation of Autonomous Driving. The data transmitted from the vehicle 30 is, for example, information indicating the travel performance of the vehicle 30 and information indicating the operation route of the vehicle 30. In the present embodiment, the data transmitted from the vehicle 30 includes information indicating the values of one or more parameters related to the automated driving of the vehicle 30. The server apparatus 40 is a computer such as a server that belongs to a cloud computing system or other computing system. The server apparatus 40 receives information transmitted from the vehicle 30 indicating the values of one or more parameters related to the automated driving of the vehicle 30. When the server apparatus 40 receives information indicating the values of one or more parameters related to the automated driving of the vehicle 30, it transmits that information to the remote monitoring apparatus 20.

The vehicle 30 is, for example, any type of automobile such as a gasoline vehicle, a diesel vehicle, a hydrogen vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle 30, which is an AV in the present embodiment, may be driven by a driver, or the driving may be automated at any level. The term “AV” is an abbreviation of autonomous vehicle. The automation level is, for example, any one of Level 1 to Level 5 according to the level classification defined by SAE. The name “SAE” is an abbreviation of Society of Automotive Engineers. The vehicle 30 may be a MaaS-dedicated vehicle. The vehicle 30 transmits information to the server apparatus 40 indicating the values of one or more parameters related to the automated driving of the vehicle 30. Alternatively, the vehicle 30 may transmit information to the remote monitoring apparatus 20 indicating the values of one or more parameters related to the automated driving of the vehicle 30.

The network 50 includes the Internet, at least one WAN, at least one MAN, or a combination thereof. The term “WAN” is an abbreviation of wide area network. The term “MAN” is an abbreviation of metropolitan area network. The network 50 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

In the system 10, the remote monitoring apparatus 20 functions as a mobility service platform. In the present embodiment, the vehicle 30 is a bus that transports one or more passengers. In the present embodiment, the remote monitoring apparatus 20 monitors the operation of the vehicle 30 based on the values set for one or more parameters related to the automated driving of the vehicle 30. In the present embodiment, the values of each parameter and the behavior of the vehicle based on each parameter are managed as an “operation manual” at the remote monitoring center RC. At the remote monitoring center RC, the remote operator OP, as the administrator of the system 10, monitors and remotely supports the operation of the vehicle 30 based on the “operation manual”. The value of each parameter as the “operational manual” is presented to the remote operator OP as a characteristic of the behavior of the vehicle 30. By referring to the “operation manual”, the remote operator OP can determine the characteristics of the behavior of the vehicle 30, such as the detection distance of obstacles and the speed at which the vehicle is slowing down.

In the present embodiment, parameters related to the automated driving of the vehicle 30 include parameters related to the control of the operating state of the vehicle 30 and parameters related to the automated driving function of the vehicle 30. The parameters related to the control of the operating state of the vehicle 30 are parameters related to the control of the engine, motor, brakes, or the like of the vehicle 30. The parameters related to the control of the operating state of the vehicle 30 include, for example, the speed, acceleration, cabin temperature, the state of opening and closing of the entry/exit doors, distance traveled, number of passengers, sales, engine speed, coolant temperature, amount of steering wheel operation, amount of fuel remaining of the vehicle 30, and, if the vehicle 30 is an FCEV, include parameters indicating the setting for the state of charge of the fuel cell. The parameters related to the automated driving functions of the vehicle 30 are, for example, parameters necessary to achieve automated driving, and are parameters related to functions that are add-on to the software that controls the operation of the vehicle 30. Parameters related to the automated driving function of the vehicle 30 include, for example, parameters indicating the distance to obstacles, speed settings for each route, reception level of GPS signals for self-position estimation, anti-collision sensors, sensors for obstacle detection, cameras installed outside the vehicle, and other settings.

The background of the present embodiment is described in detail. The values of the parameters for controlling the automated driving of the vehicle may be changed by the engineer on site. Parameter values may be changed, for example, before the start of test operations, after the start of actual production operations, or after the start of production operations in response to changes in the traffic environment. Changes in the traffic environment include, for example, an increase or decrease in the number of traffic signals and an increase or decrease in traffic volume compared to the beginning of the operation.

As an example, a parameter to be set for the anti-collision sensor or the sensor for obstacle detection could be the timing to recognize the obstacle and start avoidance. In this case, the value set as the default value is generally planned so that the obstacle is recognized from a distance and avoidance is made well in advance. As a result, a relatively gradual avoidance path is generated. However, when obstacles must be avoided in succession due to road conditions at the site, etc., if the parameters are left at their default values, the first obstacle may be avoided too gently and the second one cannot be avoided. In such cases, the engineer on site will change the value of said parameter so that the second obstacle can be properly avoided. If the parameter values are changed on site and the changed parameter values are not reflected in the remote monitoring apparatus 20 of the remote monitoring center RC, the remote operator OP of the remote monitoring center RC may stop the operation of the vehicle 30 for confirmation as the actual traveling condition of the vehicle 30, which is known based on the “operation manual”, is different from the expected traveling condition based on the “operation manual”. As a result, the operation efficiency of the vehicle 30 is reduced. If the remote monitoring center RC is unaware of on-site changes in parameter values and operates the vehicle 30 remotely based on the “operation manual” that shows the parameter values before the change, the worst-case scenario is also a risk of causing a contact accident. Therefore, if the value of a parameter is changed on site, it is desirable that the changed value of the parameter be promptly reflected in the remote monitoring apparatus 20 at the remote monitoring center RC.

In the system 10 for the present embodiment, the remote monitoring apparatus 20 stores in advance first information D1 indicating values of one or more parameters transmitted from the vehicle 30 at a first timing t1. Upon acquiring second information D2 indicating the values of one or more parameters transmitted from the vehicle 30 at a second timing t2 later than the first timing t1, the remote monitoring apparatus 20 compares the first information D1 stored in advance with the second information D2 and generates update information D3 indicating that the value of a parameter has been updated according to the comparison result. The remote monitoring apparatus 20 outputs the generated update information D3.

According to the present embodiment, when the values of parameters related to the automated driving of the vehicle 30 are changed by an engineer in on-site adaptation through an adjustment called tuning, the data reflecting such changes are output as the update information D3 at the remote monitoring center RC. Thus, the remote operator OP can properly ascertain the values of the parameters set for the vehicle 30. In addition, the traveling condition of the vehicle 30 as ascertained by the remote operator OP will no longer differ from the actual traveling condition. As a result, the remote operator OP is less likely to stop the operation of the vehicle 30 for confirmation. As a result, the operation efficiency of the vehicle 30 is improved.

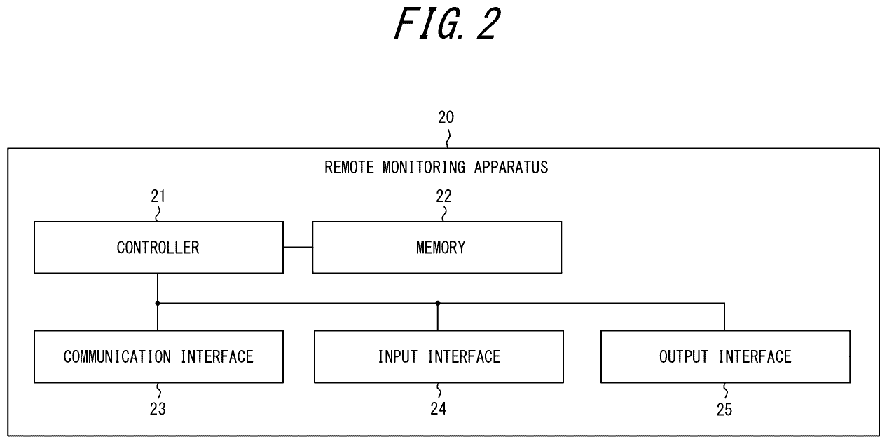

A configuration of the remote monitoring apparatus 20 according to the present embodiment will be described with reference to FIG. 2.

The remote monitoring apparatus 20 includes a controller 21, a memory 22, a communication interface 23, an input interface 24, and an output interface 25.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to the operations of the remote monitoring apparatus while controlling the components of the remote monitoring apparatus 20.

The memory 22 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data to be used for operations of the remote monitoring apparatus 20 and data obtained by the operations of the remote monitoring apparatus 20. Furthermore, in the present embodiment, the memory 22 stores the first information D1 indicating the values of one or more parameters transmitted from the vehicle 30 at the first timing t1. The memory 22 may also store the second information D2 indicating the values of one or more parameters transmitted from the vehicle 30 at the second timing t2 later than the first timing t1.

The communication interface 23 includes at least one interface for communication. The interface for communication is, for example, a LAN interface. The communication interface 23 receives data to be used for the operations of the remote monitoring apparatus 20, and transmits data obtained by the operations of the remote monitoring apparatus 20. In the present embodiment, the communication interface 23 communicates with the server apparatus 40. The communication interface 23 may communicate with the vehicle 30.

The input interface 24 includes at least one interface for input. The interface for input is, for example, a physical key, a capacitive key, a pointing device, a touch screen integrally provided with a display, or a microphone. The input interface 24 accepts operations to input data by the administrator of the remote monitoring center RC. In the present embodiment, when the remote operator OP updates the value of a parameter manually, the input interface 24 accepts the operation in which the remote operator OP enters the value of the parameter. Instead of being included in the remote monitoring apparatus 20, the input interface 24 may be connected to the remote monitoring apparatus 20 as an external input device. As the connection method, any technology such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 25 outputs the data received by the remote monitoring apparatus 20. In the present embodiment, the output interface 25 outputs the update information D3 generated by the remote monitoring apparatus 20 as an “operation manual”. The update information D3 will be described later. The output interface 25 may be connected to the remote monitoring apparatus 20 as an external output device, instead of being included in the remote monitoring apparatus 20. As the connection method, any technology such as USB, HDMI® (HDMI is a registered trademark in Japan, other countries, or both), or Bluetooth® (Bluetooth is a registered trademark in Japan, other countries, or both) can be used.

The functions of the remote monitoring apparatus 20 are realized by execution of a remote monitoring program according to the present embodiment by a processor serving as the controller 21. That is, the functions of the remote monitoring apparatus 20 are realized by software. The remote monitoring program causes a computer to execute the operations of the remote monitoring apparatus 20, thereby causing the computer to function as the remote monitoring apparatus 20. That is, the computer executes the operations of the remote monitoring apparatus 20 in accordance with the remote monitoring program to thereby function as the remote monitoring apparatus 20.

The program to control the remote monitoring apparatus 20 can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. The program encompasses information that is to be used for processing by an electronic computer and is thus equivalent to a program. For example, data that is not a direct command to a computer but has a property that regulates processing of the computer is “equivalent to a program” in this context.

Some or all of the functions of the remote monitoring apparatus 20 may be realized by a programmable circuit or a dedicated circuit serving as the controller 21. That is, some or all of the functions of the remote monitoring apparatus 20 may be realized by hardware.

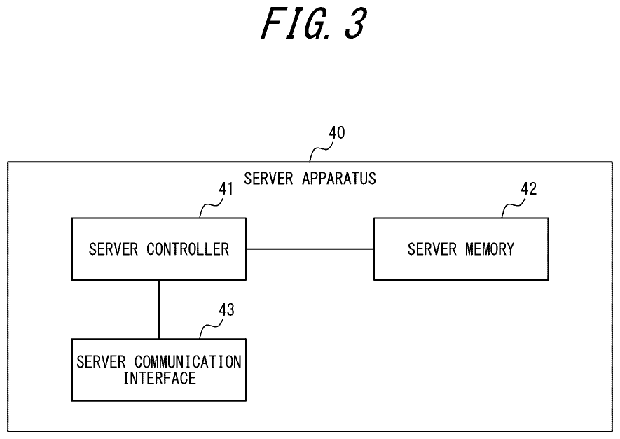

A configuration of the server apparatus 40 according to the present embodiment will be described with reference to FIG. 3.

The server apparatus 40 includes a server controller 41, a server memory 42, and a server communication interface 43.

The server controller 41 includes at least one processor, at least one programmable circuit, at least one dedicated circuit, or any combination thereof. The processor is a general purpose processor such as a CPU or a GPU, or a dedicated processor that is dedicated to specific processing. The programmable circuit is, for example, an FPGA. The dedicated circuit is, for example, an ASIC. The server controller 41 executes processes related to operations of the server apparatus 40 while controlling components of the server apparatus 40.

The server memory 42 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The server memory 42 functions as, for example, a main memory, an auxiliary memory, or a cache memory. The server memory 42 stores data to be used for the operations of the server apparatus 40 and data obtained by the operations of the server apparatus 40.

The server communication interface 43 includes at least one interface for communication. The interface for communication is, for example, a LAN interface. The server communication interface 43 receives data to be used for the operations of the server apparatus 40, and transmits data obtained by the operations of the server apparatus 40. In the present embodiment, the server communication interface 43 communicates with the vehicle 30 and the remote monitoring apparatus 20.

Some or all of the functions of the server apparatus 40 may be realized by a programmable circuit or a dedicated circuit serving as the server controller 41. That is, some or all of the functions of the server apparatus 40 may be realized by hardware.

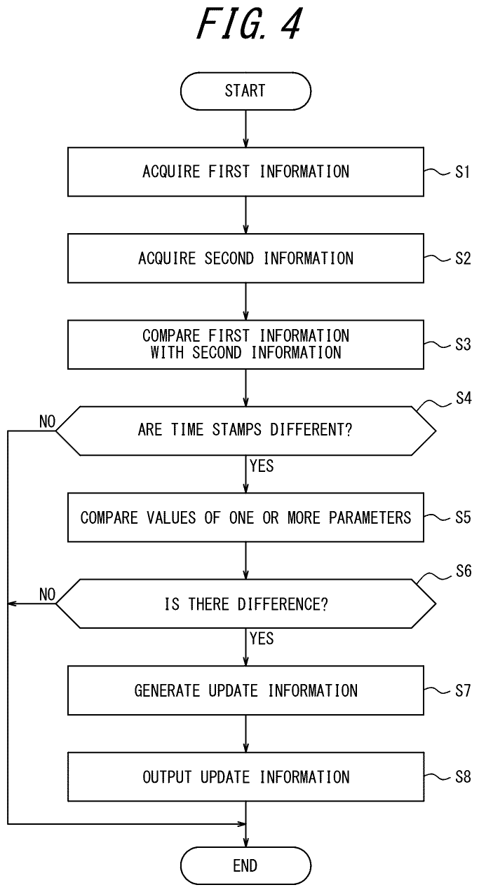

Operations of the system 10 according to the present embodiment will be described with reference to FIG. 4. These operations correspond to a remote monitoring method according to the present embodiment. FIG. 4 illustrates operations of the remote monitoring apparatus 20.

In S1 (each step of the flowchart is hereinafter identified by S and a number), the controller 21 of the remote monitoring apparatus 20 acquires the first information D1 indicating the values of one or more parameters transmitted from the vehicle 30 at the first timing t1. In the present embodiment, the first information D1 is transmitted from the vehicle 30 to the server apparatus 40 at the first timing t1. The first timing t1 may be set arbitrarily, for example, at the Nth startup of the vehicle 30. “N” is a natural number. The server apparatus 40 receives the first information D1 transmitted from the vehicle 30 via the server communication interface 43 and transmits the received first information D1 to the remote monitoring apparatus 20. At this time, the server apparatus 40 transmits the first information D1 in conjunction with an ID or the like to identify the vehicle 30. The term “ID” is an abbreviation of identifier. In the present embodiment, a time stamp indicating the latest time at which the values of one or more parameters are set in the vehicle 30 is also attached to the first information D1. The controller 21 of the remote monitoring apparatus 20 receives, via the communication interface 23, the first information D1 transmitted from the server apparatus 40. The controller 21 stores the received first information D1 in the memory 22. As a result, the first information D1 is stored in advance in the memory 22 of the remote monitoring apparatus 20. The controller 21 of the remote monitoring apparatus 20 then retrieves the first information D1 from the memory 22. In the present embodiment, the remote monitoring apparatus 20 is configured to receive the first information D1 via the server apparatus 40, but the remote monitoring apparatus 20 may communicate with the vehicle 30 and receive the first information D1 from the vehicle 30.

In S2, the controller 21 of the remote monitoring apparatus 20 acquires the second information D2 indicating the values of one or more parameters transmitted from the vehicle 30 at the second timing t2 later than the first timing t1. The second information D2 may be acquired by any procedure, for example, in the same manner as the procedure for acquiring the first information D1 in S1. The second timing t2 can be any timing later than the first timing t1, for example, at the N+1th startup of the vehicle 30.

When parameter values are changed by engineers on site, one way to reflect the changed parameter values in the remote monitoring apparatus 20 at the remote monitoring center RC is to increase the number of times the information is transmitted and update it more frequently. However, frequent updates increase the processing load on each of the remote monitoring apparatus 20, vehicle 30, and server apparatus 40 that performs data transmission. Furthermore, as the number of vehicles managed by the remote monitoring apparatus 20 increases, the load may increase cumulatively. Therefore, by limiting the timing for acquiring the first information D1 and the second information D2 to, for example, when the vehicle 30 starts up, as in the present embodiment, the processing load of each apparatus in the system 10 can be reduced compared to the case where updates are performed frequently.

Similarly to the first information D1, a time stamp indicating the latest time at which the values of one or more parameters are set in the vehicle 30 is attached to the second information D2. Therefore, if the value of a parameter is changed between the first timing t1 and the second timing t2, such that the value of the parameter is changed by local adaptation, the first information D1 and the second information D2 will have different time stamps. On the other hand, if the value of the parameter is not changed between the first timing t1 and the second timing t2, the first information D1 and the second information D2 will have the same time stamp.

In S3, the controller 21 of the remote monitoring apparatus 20 compares the first information D1 acquired in S1 with the second information D2 acquired in S2. Specifically, the controller 21 compares a first time stamp T1 attached to the first information D1 with a second time stamp T2 attached to the second information D2.

In S4, the controller 21 of the remote monitoring apparatus 20 determines whether the first time stamp T1 and the second time stamp T2 are different. If it is determined that the first time stamp T1 and the second time stamp T2 are different, the process of S5 is performed. On the other hand, if it is determined that the first time stamp T1 and the second time stamp T2 are the same, the process in FIG. 4 ends.

In S5, the controller 21 of the remote monitoring apparatus 20 compares the value indicated by the first information D1 with the value indicated by the second information D2 for one or more parameters. Specifically, the controller 21 compares the value indicated by the first information D1 with the value indicated by the second information D2 for one or more parameters. Thus, in the present embodiment, the first time stamp T1 and the second time stamp T2 are compared, and only when it is determined that the first time stamp T1 and the second time stamp T2 are different, the value indicated by the first information D1 and the value indicated by the second information D2 are compared. Therefore, the processing load at the remote monitoring apparatus 20 can be reduced compared to the case where the values indicated by the first information D1 and the second information D2 are compared with the values indicated by the second information D2 for all of the first information D1 and the second information D2 acquired at different times.

As a variation of the present embodiment, in S5, the controller 21 of the remote monitoring apparatus 20 may select a predetermined parameter set in advance among one or more parameters and compare a value indicated by the first information D1 with the value indicated by the second information D2 for the selected predetermined parameter. The parameters to be selected may be defined arbitrarily, for example, parameters that affect the driving of the vehicle 30 or the safety of the vehicle 30 can be defined as predetermined parameters. Examples of parameters that affect the driving of the vehicle 30 include the speed of the vehicle 30, acceleration, engine speed, coolant temperature, and parameters that indicate the setting of the amount of steering wheel operation. Parameters that affect the safety of the vehicle 30 include the distance to obstacles, the speed setting for each route, and parameters that indicate the setting of the state of the anti-collision sensors and sensors for obstacle detection. According to the present variation, parameters that affect the driving of the vehicle 30 or parameters that affect the safety of the vehicle can be compared preferentially, thereby reducing the processing load on the remote monitoring apparatus 20 while maintaining the driving safety of the vehicle 30 compared to the case where all of one or more parameters are compared.

In S6, the controller 21 of the remote monitoring apparatus 20 determines whether there is a difference in the values of each parameter compared in S6. Any procedure may be used to determine whether there is a difference. The following procedure, for example, may be used. The controller 21 compares the values of the corresponding parameters and determines that there is a difference if the values are different. Alternatively, the controller 21 may determine that there is a difference if the values are different and the difference is greater than a threshold value. The threshold value may be determined arbitrarily; for example, it should be determined within a range where different values of the parameters have little or no impact on the actual traveling of the vehicle 30. If it is determined that there is a difference in S6, the process of S7 is performed. On the other hand, if it is determined that there is no difference, the process in FIG. 4 ends.

In S7, the controller 21 of the remote monitoring apparatus 20 generates the update information D3 indicating that the value of a parameter has been updated. Specifically, the controller 21 creates, as the update information D3, information indicating the value indicated by the second information D2 as the value of the parameter. For example, the controller 21 creates the update information D3 by reflecting the values indicated by the second information D2 in the values of each parameter indicated in the “operation manual” managed at the remote monitoring center RC.

Alternatively, the controller 21 of the remote monitoring apparatus 20 may create, as the update information D3, information indicating an error in relation to a parameter that is determined to have a difference in value in S6. Specifically, the controller 21 may generate error messages as the update information D3. The controller 21 may generate as an error massage, for example, a message, “The value of parameter X has been changed. Please check it”.

In S8, the controller 21 of the remote monitoring apparatus 20 outputs the update information D3 created in S7. Specifically, the controller 21 controls the display of the value indicated by the second information D2 as indicated by the update information D3 on the display, which is the interface for output as the output interface 25. For example, the controller 21 causes the display to display the “operation manual” reflecting the value indicated by the second information D2. Alternatively, if the controller 21 of the remote monitoring apparatus 20 generates an error message as the update information D3, it may control the display of the generated message on the display, which is the interface for output as the output interface 25 of the remote monitoring apparatus 20. Instead of displaying the error message on the display, the controller 21 may output the error message audibly on a speaker. By outputting information indicating an error for the parameter whose value has been changed as the update information D3, the remote operator OP can manually update the value of the parameter at the remote monitoring apparatus 20 after visually checking what is actually happening in the vehicle 30 as a result of the change in the value of the parameter.

As a variation of the present embodiment, the controller 21 of the remote monitoring apparatus 20 may further control the display of the update information D3 created in S7 on the vehicle 30. The control of displaying the update information D3 on the vehicle 30 may be performed by any procedure, for example, the following procedure. The controller 21 of the remote monitoring apparatus 20 transmits the update information D3 to the server apparatus 40 via the communication interface 23. The server controller 41 of the server apparatus 40 receives the update information D3 via the server communication interface 43 and transmits the received update information D3 to the vehicle 30 via the server communication interface 43. The vehicle 30 receives the update information D3 and displays the update information D3 on a display or other interface for output on the vehicle 30. Alternatively, the controller 21 of the remote monitoring apparatus 20 may communicate with the vehicle 30 via the communication interface 23 and transmit the update information D3 directly to the vehicle 30 without going through the server apparatus 40. By displaying the update information D3 on the vehicle 30, it is convenient for the engineer who performs the tuning work on site to check the changed parameter values on site.

Thus, the remote monitoring apparatus 20 monitors the operation of the vehicle 30 based on the values set for one or more parameters related to the automated driving of the vehicle 30. The remote monitoring apparatus 20 stores in advance the first information D1 indicating the values of one or more parameters transmitted from the vehicle 30 at the first timing t1, and compares, upon acquiring the second information D2 indicating the values of one or more parameters transmitted from the vehicle 30 at the second timing t2 later than the first timing t1, the first information D1 stored in the memory 22 with the second information D2, and generates the update information D3 indicating that the value of the parameter has been updated according to the comparison result. The remote monitoring apparatus 20 outputs the generated update information D3.

According to the present embodiment, when the values of parameters related to the automated driving of the vehicle 30 are changed by an engineer through tuning in on-site adaptation, the data reflecting such changes are output as the update information D3 at the remote monitoring center RC. Thus, the remote operator OP can properly ascertain the values of the parameters set for the vehicle 30. As a result, the traveling condition of the vehicle 30 as ascertained by the remote operator OP is more likely to match the actual traveling condition, so the remote operator OP is less likely to stop the operation of the vehicle 30 for confirmation. Therefore, the operation efficiency of the vehicle 30 is improved.

As a variation of the present embodiment, the controller 21 of the remote monitoring apparatus 20 may calculate, based on a difference in value, the amount of change that occurs in actual traveling of the vehicle 30 in relation to the parameter for which it is determined that there is the difference, and control output of information indicating the calculated amount of change together with the update information D3. Specifically, for a parameter whose value is determined to have a difference in S6, the controller 21 calculates in S7 how the actual traveling of the vehicle 30 changes as a result of the change in the value of that parameter. The controller 21 may then display the information indicating the calculated change on the display as the output interface 25 in S8. As an example, suppose that in S6, it is determined that there is a difference in the values of parameters related to vehicle speed, acceleration, and battery consumption of the vehicle 30. In S7, the controller 21 calculates the vehicle speed, acceleration, and battery consumption during one lap of the operation route of the vehicle 30 based on the values before and after the change of the parameters related to vehicle speed, acceleration, and battery consumption, respectively. In S8, when displaying the update information D3 in the output interface 25, the controller 21 may also display a comparison of the vehicle speed, acceleration, and battery consumption of the vehicle 30 before and after changing the parameter values.

In general, it is difficult to immediately predict changes in actual driving from changes in parameter values. According to this variation, it is easier for the remote operator OP to understand how and how much a change in parameter values affects the entity driving of the vehicle 30. This improves convenience.

The present disclosure is not limited to the embodiment described above. For example, a plurality of blocks described in the block diagram may be integrated, or a block may be divided. Instead of executing a plurality of steps described in the flowchart in chronological order in accordance with the description, the plurality of steps may be executed in parallel or in a different order according to the processing capability of the apparatus that executes each step, or as required. Other modifications can be made without departing from the spirit of the present disclosure.

1. A remote monitoring apparatus for monitoring an operation of a vehicle based on values set for one or more parameters related to automated driving of the vehicle, the remote monitoring apparatus comprising:
a memory configured to store in advance first information indicating values of the one or more parameters transmitted from the vehicle at a first timing; and
a controller configured to:
compare, upon acquiring second information indicating values of the one or more parameters transmitted from the vehicle at a second timing later than the first timing, the first information stored in the memory with the second information; and
generate update information indicating that a value of a parameter has been updated according to a comparison result.

2. The remote monitoring apparatus according to claim 1, wherein
a corresponding time stamp indicating a latest time at which values of the one or more parameters are set in the vehicle is attached to each of the first information and the second information, and
the controller is configured to:
compare a first time stamp attached to the first information with a second time stamp attached to the second information;
determine whether there is a difference by comparing the values indicated by the first information with the values indicated by the second information for the one or more parameters in a case in which the first time stamp and the second time stamp are different; and
generate the update information in a case in which it is determined that there is a difference.

3. The remote monitoring apparatus according to claim 2, wherein the controller is configured to:
select a predetermined parameter set in advance among the one or more parameters in a case in which the first time stamp and the second time stamp are different; and
compare a value indicated by the first information with a value indicated by the second information for the selected predetermined parameter.

4. The remote monitoring apparatus according to claim 2, wherein the controller is configured to:
create, as the update information, information indicating a value indicated by the second information as a value of a parameter in a case in which it is determined that there is a difference between a value indicated by the first information and a value indicated by the second information for the parameter; and
control output of the created update information.

5. The remote monitoring apparatus according to claim 4, wherein the controller is configured to:
calculate, based on a difference in value, an amount of change that has occurred in actual traveling of the vehicle in relation to a parameter for which it is determined that there is the difference; and
control output of information indicating the calculated amount of change together with the update information.
